(19) United States
(12) Patent Application Publication
(10) Pub. No.: US 2015/0285908 A1
(43) Pub. Date: Oct. 8, 2015

(54) PORTABLE ECHO SOUNDER

(71) Applicant: Aleksei Olegovich Tikhomirov, Saint Petersburg (RU)

(72) Inventor: Aleksei Olegovich Tikhomirov, Saint Petersburg (RU)

(73) Assignee: Ltd &lt;&lt;NT-Leasing&gt;&gt;, d. Vistino (RU)

(21) Appl. No.: 14/243,532

(22) Filed: Apr. 2, 2014

(51) Int. Cl. G01S 15/02

(52) U.S. Cl. CPC G01S 15/02

(57) ABSTRACT

The present invention relates to devices for searching for and detecting fish in the water and is suitable for personal use when fishing. A portable echo sounder comprises a submersible unit and an above-water electronic unit connected to each other via a sealed conductive cable. The submersible unit comprises a signal transducer sensor and an autonomous power source connected thereto. The above-water electronic unit comprises a voltage converter, a sensor control unit, a signal processing unit, a signal interpretation unit and a display connected in series. The signal interpretation unit is connected to each of the other units of the above-water electronic unit. The signal transducer sensor and the autonomous power source of the submersible unit are connected to one end of the cable, and the sensor control unit, the signal processing unit and the voltage converter are connected to the other end of the cable. The voltage converter is connected to each of the other units of the of the above-water electronic unit. The portable echo sounder structure allows for operation in extreme weather conditions, i.e. at high and low air temperatures.

### FIELD OF THE DISCLOSURE

The present invention relates to devices for searching and detecting fish in water and is suitable, for example, in personal fishing.

### BACKGROUND OF THE DISCLOSURE

Fish detection equipment is widely used on fishing vessels as well as in personal fishing.

Thus, RU 2275654, publ. 27 Apr. 2006, discloses “A Device for Searching and Detecting Fish”.

The device is intended for use on fishing fleet vessels and comprises an underwater acoustic emitting/receiving system and an above-water electronic system for processing, storing and displaying the received acoustic data. The underwater acoustic emitting/receiving system n echo sounder sensors of vertical sounding, wherein acoustic arrays of each sensor are two-section arrays or three-section arrays, and each echo sounder sensor is provided with two additional channels for receiving echo signals in addition to the main channel. The above-water electronic system comprises a drive circuit, a unit for fish signal separation, a unit for extraction of signal originating from the same fish specimens, and a unit for processing, storing, presenting and displaying data. The device in whole is complex and heavy.

A portable echo sounder suitable for personal fishing is disclosed in U.S. Pat. No. 7,554,884 for a “Simplicity sonic depth finder for fishing”, publ. 28 Jun. 2007.

The portable echo sounder for fishing comprises a sensor for transmitting an ultrasonic signal into the water in a fishing site and receiving a reflective ultrasonic signal reflected from an underwater object, a control unit for analyzing and/or determining the obtained data, sensor indicators, and a switching unit for obtaining electric power supplied from a power source, wherein sensors, the control unit and the electronic unit are incorporated in a sealed body. The wireless signal is transmitted from the transmitter of the fishing detector to a distant transceiver and displayed by a display such as a personal portable communications terminal, e.g. a mobile telephone.

Still another fish detector disclosed in WO 2013108088, publ. 25 Jul. 2013, for a “Tablet or smart phone compatible fish finder device”, allows not only detecting fish, but also determining its size, location depth and motion parameters.

The known fish finder device consists of a buoyant housing, in which an acoustic transmitter and a receiver are disposed, and which communicates via digital wireless connection (satellite, the Internet) with display devices, preferably portable communication devices, such as, for example, smart phones, tablets, laptop computers, etc.

Another approach is described in U.S. Pat. No. 6,791,902, publ. 14 Sep. 2004, for a “Portable fish finder”.

The portable device can be used with a water craft associated with water-related sports activities: sailing, fishing, etc., and is intended for detecting fish or other objects at various depths. The fish finder device comprises a portable housing containing a data processing and storage device with a display for presenting said data, and a battery. The fish finder device is provided with cavities for storing a power cable and with a depth sensor. In working position, the portable housing is disposed on the body of a water craft, and the depth sensor is submerged in a body of water and connected to a data processing and storage sensor and a display via a signal cable.

Still another system and method permit detection of objects, including fish, within a body of water located below a body of ice, see U.S. Pat. No. 5,546,362 for a “Depth finder transducer system”. The system includes a power unit and a display unit on the surface of the body of ice, wherein said display unit is connected to a depth sensor transducer via an electrically conductive flexible cable submerged in the water through a hole in the body of ice. Furthermore, the system is provided with a positioning means for selectively fixing the conductive cable, thus allowing for vertical alignment of the depth sensor.

Further, a portable echo sounder is disclosed and described on the website http://www.adrenalin.ru/catalog/element.php.

The JJ-CONNECT FISHERMAN WIRELESS 3 Deluxe portable echo sounder comprises two sensors (a wired sensor and a wireless sensor).

When the echo sounder comprises a wired sensor attached to the transom, the wired sensor has a high-frequency 200 kHz impulse forming a relatively narrow beam (45°). The wired sensor is able to sufficiently detect seabed profile and precise depth (excluding silt deposits) in a range of up to 100 m. The device is powered by a 12-18V cigarette lighter or a 220V power supply via a power cable.

The advantage of an echo sounder with a wireless sensor is provided by a built-in Li-Ion battery. The wireless float sensor operates at a distance of up to 40 m from the echo sounder and has a lower frequency 125 kHz impulse, forming a wide beam (90°). Said sensor is sufficiently sensitive to detect small fish, seabed texture and silt deposit depth.

The high-contrast display of the device provides image visibility even under direct sunlight; further, an adjustable display backlight is provided.

The echo sounder is received in a rubberized housing and conforms to IPx7 waterproofing standard. The JJ-CONNECT FISHERMAN WIRELESS 3 Deluxe echo sounder is disposed in a plastic case convenient for transport and storage.

In all devices known in the art the autonomous power sources (batteries, rechargeable units) are arranged in the open air, i.e. on the bank or on water craft. However, the operation of electronic devices at low temperatures (below 10-15° C.) in personal fishing has specific power source requirements. It is known that low temperatures in winter, as well as high temperatures in summer, have an adverse effect on capacity of most chemical power sources of electronic hardware.

The object of the present invention is to provide a portable echo sounder which is capable of operation in extreme weather conditions, i.e. at high and low ambient temperatures.

### SUMMARY

An embodiment of the disclosure is directed to a portable echo sounder comprising a submersible unit comprising a signal transducer sensor and an autonomous power source, and an above-water electronic unit, wherein said units are connected to each of the other units via a sealed conductive cable. The above-water electronic unit comprises a voltage converter, a sensor control unit, and a signal processing unit, a signal interpretation unit and a display connected in series, wherein the signal interpretation unit controlling the operation of the echo sounder is connected to each of the other units of the electronic unit.

All elements of the above-water electronic unit of the echo sounder are powered by an autonomous power source arranged in the submersible unit via the sealed conductive cable.

The signal transducer sensor formed by e.g. a piezoceramic plate converts the electrical signal received from the above-water unit via the cable into an acoustic wave and transmits said wave into the body of water; said sensor further converts the acoustic wave reflected from an object (fish, seabed, tree, etc.) back into an electrical signal transferred back to the above-water unit via the cable.

In the echo signal transmission mode, the signal interpretation unit is connected with the signal transducer sensor through the sensor control unit via the conductive cable, whereas in the reflected signal reception mode, the signal transducer sensor is connected with the signal processing unit via the conductive cable, and further is connected with the signal interpretation unit and the display connected to said signal processing unit in series.

The autonomous power source in the submersible unit is directly connected to the echo signal transducer sensor, and further is connected to each of the other units of the above-water electronic unit by means of the sealed conductive cable via the voltage converter.

The electronic units of the disclosed echo sounder provide the following functions. The sensor control unit determines the mode of operation thereof (alternating between transmission and reception of echo signals); the signal processing unit extracts the required signal from the overall signal and amplifies it; the signal interpretation unit digitizes the amplified signals, calculates time passed between transmitting the signal and receiving an echo signal from all objects along the line, calculates size of objects based on the received echo signals, processes signals for transmission thereof to the display, and provides general control over the operation of echo sounder; and the voltage converter converts voltage received from the autonomous power source (in the submersible unit) into operating voltages for all electronic (above-water) units.

Structurally, the portable echo sounder therefore consists of two parts: the above-water electronic unit and the submersible unit comprising the signal transducer sensor and the autonomous power source connected via the sealed conductive cable.

In another embodiment, the sealed conductive cable of the portable echo sounder is elastic and frost-proof.

The difference of embodiments of the disclosed portable echo sounder compared to the prior art is in particular in that power sources of the device are arranged near the transducer sensor and are submerged in the body of water during echo sounder operation. The submersible unit with the transducer sensor and the autonomous power source forms a completely sealed structure of the submersible unit. The electronic unit houses only electronic components, control buttons and the display.

Water temperature in winter is known to be stable (within the +2 to +4° C. range). Therefore, due to the structural coupling of the power source and the signal transducer sensor, embodiments of the disclosed portable echo sounder allows to eliminate the effect of sub-zero temperatures on the power source, since the power source is practically always held at above-zero temperatures. In summer, said echo sounder structure further prevents power source from overheating, since water temperature is always lower than air temperature, and the power source is comfortably arranged in the water.

Therefore, embodiments of the portable echo sounder structure allows for operation in extreme weather conditions, i.e. at high and low ambient temperatures.

An echo sounder provided with an elastic and frost-proof cable (e.g. an organosilicon rubber (silicon) sleeve) allows to extend time of use of the echo sounder even at extreme low temperatures, as said sleeve is resistant to cracking and fracturing.

Embodiments of the disclosed portable echo sounder device invention will be further better understood with reference to accompanying figures, wherein:

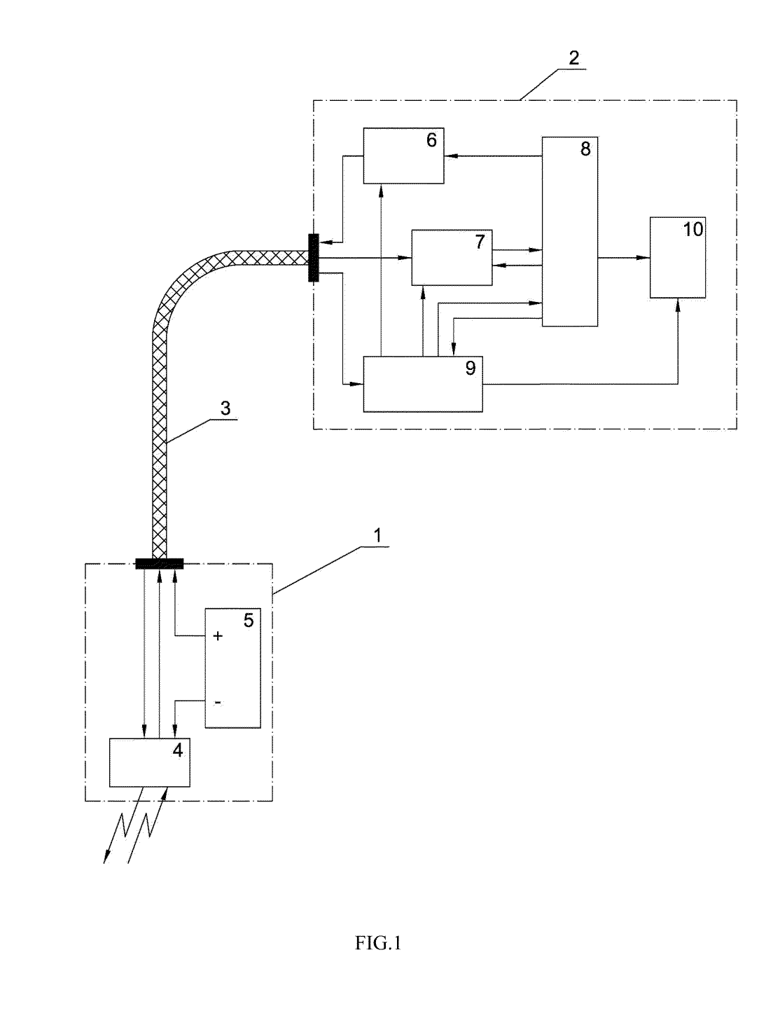

FIG. 1 shows a block diagram of the portable echo sounder according to an embodiment of the present invention;

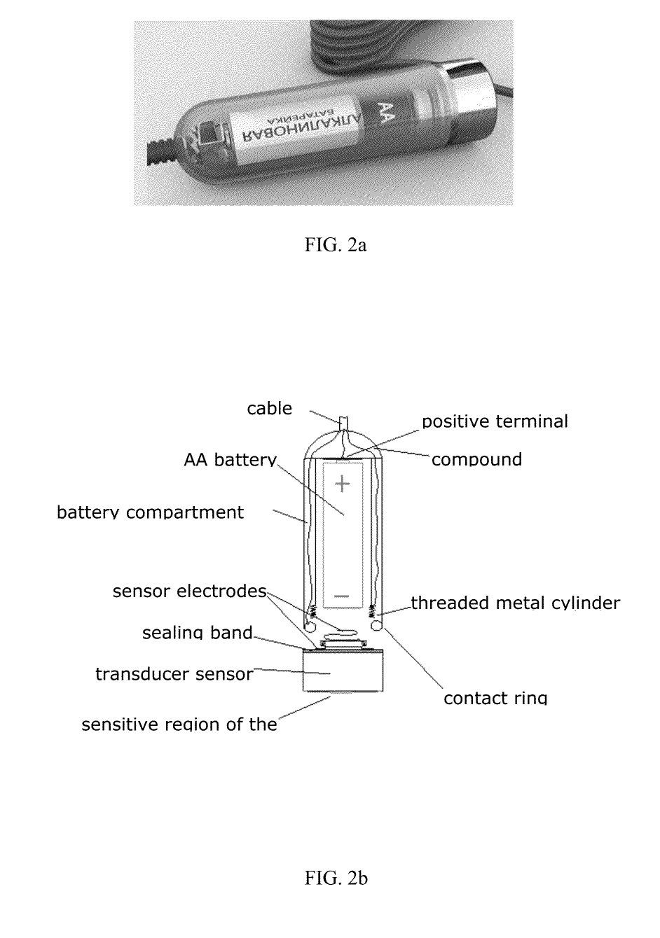

FIG. 2a shows a perspective view of an embodiment of the submersible echo sounder unit with a sensor combined with an autonomous power source;

FIG. 2b shows an internal structure view of an embodiment of the submersible echo sounder unit with a sensor combined with an autonomous power source;

### DETAILED DESCRIPTION OF ILLUSTRATIVE EMBODIMENTS

In one exemplary embodiment of the disclosure, an echo sounder device

(FIG. 1) comprises a submersible sealed unit 1 and an above-water electronic unit 2, connected to each other via a sealed conductive cable 3.

The submersible unit 1 comprises an echo signal transducer sensor 4 and an autonomous power source 5 connected to the echo signal transducer sensor 4, wherein sensor 4 and power source 5 are electrically connected to corresponding wires of cable 3.

The above-water electronic unit 2 comprises a sensor control unit 6, a signal processing unit 7, a signal interpretation unit 8, a voltage converter 9 and a display 10. The sensor control unit 6, the signal processing unit 7, and the voltage converter 9 are connected directly to corresponding wires of cable 3. The signal interpretation unit 8 is connected to each of the other units 6, 7, 9 and 10 of the above-water electronic unit. The voltage converter 9 is also connected to each of the other units 6, 7, 8, 10 of the above-water electronic unit.

The embodiment of the portable echo sounder shown in FIG. 1 is operated as follows.

When the echo sounder is actuated by means of a button on a panel of the above-water electronic unit 2, the electric impulse from the actuated signal interpretation unit 8 is transmitted through the sensor control unit 6 via the conductive cable 3 to the echo signal transducer sensor 4 of the submersible sealed unit 1. Sensor 4, for example formed by a piezoceramic plate with resonance frequency of 250 kHz, converts the electric signal received via cable 3 in transmission mode into an acoustic wave and transmits said wave into the body of water. When the acoustic wave reaches an object (fish, seabed, tree, etc.), it reflects therefrom. The reflected acoustic wave is transmitted back to the sensor 4 (the piezoceramic plate) operating in reception mode as a receiver (microphone), wherein said wave is converted back into an electric signal, which is transmitted to the signal processing unit 7 of the above-water unit 2 via cable 3. The signal processing unit 7 extracts the required signal from the overall signal and amplifies it, then the signal is transmitted to the signal interpretation unit 8. The signal interpretation unit 8 digitizes the amplified signals, calculates time passed between transmitting the signal and receiving an echo signal from all objects along the line, calculates size (dimensions) of objects based on the received echo signals, and processes said signals for transmission thereof to the display 10.

All units of the echo sounder are powered by the autonomous power source 5 arranged in the submersible sealed unit 1: the echo signal transducer sensor 4 is powered directly, and other units of the above-water electronic unit 2 (i.e., units 6, 7, 8, 10) are powered via the conductive cable 3 through voltage converter 9 which converts power voltage of the autonomous power source 5 into operating voltages for all electronic units and is arranged in the above-water electronic unit 2 along with the other units.

Due to the fact that the autonomous power source 5 is practically always held at above-zero temperatures in the water, the echo sounder allows to eliminate the effect of sub-zero temperatures on the power source 5 when used in winter, and allows to prevent overheating under direct sunlight when used in summer, thus allowing operation of the disclosed echo sounder in extreme weather conditions, i.e. at high and low ambient temperatures. Furthermore, embodiments of the disclosed structure allow to increase operational life of the autonomous power source 5, and thus the operational life of the portable echo sounder in general.

According to an embodiment of the present invention, when the sealed conductive cable 3 is elastic and frost-proof cable, such cable allows to extend time of use of the echo sounder even at extreme low temperatures.

Following is an embodiment of the disclosed portable echo sounder (FIG. 2a and FIG. 2b).

The submersible sealed unit 1 comprising the sensor 4 and the autonomous power source 5 forms a completely sealed structure (IP68).

The echo signal transducer sensor 4 can be formed, for example, by a piezoceramic plate (made of lead zirconate titanate) with resonance frequency of 250 kHz received in a metal housing (e.g., made of lead) sealed with a special compound K-97 (produced by Superplast Ltd, Moscow, Russian Federation).

The autonomous power source 5 can be formed, for example, by an AA batter (1.5V) disposed in the battery compartment of the submersible unit 1.

The battery compartment of the submersible unit 1 can be formed, for example, by a cylinder made of a dielectric material, e.g. polycarbonate, acrylonitrile butadiene styrene (ABS) plastic material, or polyoxymethylene (POM) material, arranged at the upper (when submerged) part of the positive terminal of the power source 5 and the conductor weld location of the cable 3 sealed with a sealant, e.g. the epoxy compound K-97, thus providing a hermetic seal of the point of insertion of cable 3 into the unit 1. A threaded metal cylinder forming the negative terminal of the power source 5 and a contact ring providing contact between a data bus of sensor 4 and one of the conductors of cable 3 are embedded in the lower (when submerged) part of the unit 1. The lower part of the battery compartment is sealed by means of a ring made of silicon rubber. The sealed signal transducer sensor 4 structure is screwed into the battery compartment on the underside.

The submersible unit 1 (with the signal transducer sensor 4 and the autonomous power source 5) and the above-water electronic unit 2 are connected to each other by a sealed conductive cable 3, which is, for example, elastic and freezeproof. The cable can be based, for example, on MGTFE-2x0.07 cable (produced by Kama Cable JSCo) additionally covered with an organosilicon rubber sleeve using special equipment.

The structure of the electronic unit 2 containing only electronic components (units 6, 7, 8, 9), control buttons and display 10, is also hermetically sealed (IP67).

The sensor control unit 6 can be formed, for example, by a signal generator with operating frequency of 250 kHz generated directly by a microprocessor

(STM 32L151C8T6ST) connected with a transformer (ATB322524-01100 type) via a transistor (PMV-40 type).

The signal processing unit 7 can be formed, for example, by an amplifying microcircuit of SA604(614)DA type or K 157XA2 type.

The signal interpretation unit 8 can be formed, for example, by a microprocessor with a built-in analog-digital converter of STM 32L151C8T6ST type.

The voltage converter 9 for converting voltage supplied by the autonomous power supply 5 (1.5V from an AA battery) into operating voltages for operation of above-water electronic units can be formed, for example, by a voltage converter microcircuit MAX 1797EUA.

The display 10 can be formed, for example, by a Powertip LCD display (resolution: 128×64 p).

All of the aforementioned components of the electronic unit 2 are disposed in a single housing, e.g., housing made of plastic material. The structure of the electronic unit 2 is hermetically sealed by means of specific grooves formed in the housing; said grooves are filled with a special hydrophobic compound (a silicon-fluoropolymer mixture such as “VMP AVTO MS SPORT”) during assembly.

Although the present invention has been described with reference to preferred embodiments, those skilled in the art will recognize that changes may be made in form and detail without departing from the spirit and scope of the invention.

1. A portable echo sounder comprising
a submersible unit, and
an above-water electronic unit connected to the submersible unit via a sealed conductive cable,
wherein the submersible unit comprises
a signal transducer sensor and
an autonomous power source connected thereto, and
wherein the above-water electronic unit comprises
a voltage converter,
a sensor control unit, and
a signal processing unit,
a signal interpretation unit and
a display connected in series,
wherein the signal interpretation unit is connected to each of the other units of the above-water electronic unit;
wherein the signal transducer sensor and the autonomous power source of the submersible unit are connected to one end of the cable, and the sensor control unit, the signal processing unit and the voltage converter are connected to the other end of the cable, and
wherein said voltage converter is connected to each of the other units of the above-water electronic unit.

2. The portable echo sounder according to claim 1, wherein the sealed conductive cable is elastic and frost-proof.
